(19) United States
(12) Patent Application Publication
(10) Pub. No.: US 2023/0059373 A1
(43) Pub. Date: Feb. 23, 2023

(54) FLAME RETARDANT POLYMERIC COMPOSITION

(71) Applicant: Dow Global Technologies LLC, Midland, MI (US)

(72) Inventors: Bharat I. Chaudhary, Princeton, NJ (US); Andrew B. Shah, Collegeville, PA (US); Chongsoo Lim, Collegeville, PA (US)

(21) Appl. No.: 17/790,974

(22) PCT Filed: Apr. 12, 2021
(86) PCT No.: PCT/US2021/026775

§ 371 Date: Jul. 6, 2022

Related U.S. Application Data
(60) Provisional application No. 63/009,058, filed on Apr. 13, 2020.

(51) Int. Cl. C08K 5/3417; C08K 3/22

(52) U.S. Cl. CPC C08K 5/3417; C08K 3/2279

(57) ABSTRACT

A polymeric composition includes a silane functionalized polyolefin; a brominated flame retardant having a Temperature of 5% Mass Loss from 350° C. to 500° C. and from 2 wt % to 50 wt % Retained Mass at 650° C., wherein the 5% Mass Loss and Retained Mass at 650° C. are measured according to Thermogravimetric Analysis; and antimony trioxide, wherein the polymeric composition has an antimony (Sb) to bromine (Br) molar ratio (Sb:Br molar ratio) of greater than 0.0 to 0.35. A coated conductor may be formed using the polymeric composition.

### BACKGROUND

### Field of the Invention

The present disclosure relates to a composition suitable for wire and cable applications, and halogenated flame retardant compositions in particular.

### INTRODUCTION

Polymeric compositions comprising halogenated flame-retardants are known. Examples of halogenated flame retardants include brominated flame retardants. Polymeric compositions only relying on halogenated flame retardants to provide flame retardancy typically require high loadings of flame retardants, and often cannot meet the most stringent burn performance requirements. High loadings of flame retardants adversely affect the processability and mechanical performance, such as tensile elongation and impact strength, of the polymeric compositions.

During exposure to heat or flame, halogenated flame retardants are believed to form a halogenated vapor phase. The halogenated vapor phase is believed to retard flame progression through a free radical flame poisoning mechanism. In the free radical poisoning mechanism, active free radicals, that would otherwise go on to promote further exothermic reactions, are bonded with and neutralized by the halogen in the halogenated vapor.

One method of overcoming processability and mechanical performance issues associated with high halogenated filler concentration is to include a flame-retardant synergist. One example of a flame-retardant synergist is antimony trioxide. Antimony trioxide is believed to provide a synergistic effect to the halogenated filler by evolution of volatile but dense antimony halides vapors through successive transformation of halogenated antimony oxide complexes generated from reaction between brominated flame retardant and antimony oxide as the temperature increases. This bonding of the antimony and the halogen creates various vapor phase compounds having greater stability than the halogenated vapor phase without antimony. The greater stability and higher density of the antimony halides increase the residence time of the halogenated vapor phase in proximity to the combustion zone where free radical chain reactions happen so that a greater number of free radicals are poisoned and flame progression is resisted.

In view of the importance of the halogenated filler and antimony trioxide relationship, attempts at optimizing the antimony and halogen ratio in polyolefin compositions have been made. For example, U.S. Patent Application Publication Number 2019/0185654 (“'654 publication”) discloses the use of ethylene-1,2-bis(pentabromophenyl) as a halogenated flame retardant and antimony trioxide to achieve an antimony to bromine (“Sb:Br”) molar ratio of from 0.37 to 1.05. The '654 publication provides several comparative examples (i.e. comparative examples 8, 9 and 11) having Sb:Br molar ratios of less than 0.37 failing a VW-1 Burn Test, when used to make a coated conductor in wire and cable constructions.

The use of antimony trioxide as a flame-retardant synergist faces a variety of constraining pressures. For example, antimony trioxide faces regulatory pressure in certain jurisdictions to reduce or abandon its use. Further, sourcing of antimony trioxide may be constrained due to the location of natural deposits and geopolitical tensions. As such, the reduced use of antimony trioxide is desired, however the '654 publication demonstrates that too little antimony trioxide may result in compositions that exhibit unacceptable burn test properties. Further, simply increasing the halogenated filler component may negatively affect mechanical properties of the composition.

In view of the foregoing, it would be surprising to discover a polymeric composition that both enables passing of the VW-1 Burn Test and has an Sb:Br molar ratio below 0.37.

### SUMMARY OF THE DISCLOSURE

The present invention provides for a polymeric composition that both enables passing of the VW-1 Burn Test and has an Sb:Br molar ratio below 0.37.

The inventors of the present application have discovered that polymeric compositions comprising a silane functionalized polyolefin, a brominated flame retardant and antimony trioxide allows for an Sb:Br molar ratio of from greater than 0 to 0.35 while still enabling coated conductors made of the polymeric compositions to pass the VW-1 Burn Test. The polymeric composition is surprising because it was believed that an Sb:Br molar ratio below 0.37 would be too low for the antimony trioxide to effectively interact with the halogenated filler resulting in free radical propagation and the failure of the VW-1 Burn Test. The discovery of such polymeric compositions is advantageous in both providing a composition that can enable coated conductors made of the polymeric compositions to pass the VW-1 Burn Test, but a composition that also decreases the relative amount of antimony trioxide present in the composition.

The polymeric compositions comprising silane functionalized polyolefin, a brominated flame retardant and antimony trioxide of the present invention are particularly useful as jackets or insulations for wires and cables.

According to a first feature of the present disclosure, a polymeric composition includes a silane functionalized polyolefin; a brominated flame retardant having a Temperature of 5% Mass Loss from 350° C. to 500° C. and from 2 wt % to 50 wt % Retained Mass at 650° C., wherein the 5% Mass Loss and Retained Mass at 650° C. are measured according to Thermogravimetric Analysis; and antimony trioxide, wherein the polymeric composition has an antimony (Sb) to bromine (Br) molar ratio (Sb:Br molar ratio) of greater than 0.0 to 0.35.

According to a second feature of the present disclosure, the polymeric composition comprises 0.001 wt % to 5.0 wt % of a silanol condensation catalyst based on a total weight of the polymer composition.

According to a third feature of the present disclosure, the polymeric composition comprises 5 wt % to 30 wt % of a second polyolefin based on a total weight of the polymeric composition, wherein the second polyolefin has a crystallinity at 23° C. of from 0 wt % to 80 wt % as measured according to Crystallinity Testing.

According to a fourth feature of the present disclosure, the brominated flame retardant comprises ethylene bis-tetrabromophthalimide.

According to a fifth feature of the present disclosure, the polymeric composition comprises from 5 wt % to 45 wt % of ethylene bis-tetrabromophthalimide based on a total weight of the polymeric composition.

According to a sixth feature of the present disclosure, the polymeric composition comprises from 1 wt % to 15 wt % of antimony trioxide based on a total weight of the polymeric composition.

According to a seventh feature of the present disclosure, the Sb:Br molar ratio is from 0.20 to 0.30.

According to an eighth feature of the present disclosure, a coated conductor comprises a conductor; and the polymeric composition of any one of claims 1-6 disposed at least partially around the conductor.

According to a ninth feature of the present disclosure, the coated conductor passes a Horizontal Burn Test.

According to a tenth feature of the present disclosure, the coated conductor passes a VW-1 Burn Test.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut fur Normung; and ISO refers to International Organization for Standards.

As used herein, the term weight percent (“wt %”) designates the percentage by weight a component is of a total weight of the polymeric composition unless otherwise indicated.

As used herein, a “CAS number” is the chemical services registry number assigned by the Chemical Abstracts Service.

### Polymeric Composition

The present disclosure is directed to a polymeric composition. The polymeric composition comprises a silane functionalized polyolefin, a brominated flame retardant and antimony trioxide. The polymeric composition has an antimony (Sb) to bromine (Br) molar ratio (Sb:Br molar ratio) of greater than 0.0 to 0.35. The polymeric composition may optionally include a second polyolefin.

### Silane Functionalized Polyolefin

The polymeric composition comprises a silane functionalized polyolefin. A “silane-functionalized polyolefin” is a polymer that contains silane and equal to or greater than 50 wt %, or a majority amount, of polymerized α-olefin, based on the total weight of the silane-functionalized polyolefin. “Polymer” means a macromolecular compound prepared by reacting (i.e., polymerizing) monomers of the same or different type. As noted above, the polymeric composition comprises the silane-functionalized polyolefin. The silane-functionalized polyolefin crosslinks and in doing so increases the resistance to flow of the polymeric composition at elevated temperatures.

The silane-functionalized polyolefin may include an α-olefin and silane copolymer, a silane-grafted polyolefin, and/or combinations thereof. An “α-olefin and silane copolymer” (α-olefin/silane copolymer) is formed from the copolymerization of an α-olefin (such as ethylene) and a hydrolyzable silane monomer (such as a vinyl silane monomer) such that the hydrolyzable silane monomer is incorporated into the backbone of the polymer chain prior to the polymer's incorporation into the polymeric composition. A “silane-grafted polyolefin” or “Si-g-PO” may be formed by the Sioplas process in which a hydrolyzable silane monomer is grafted onto the backbone of a base polyolefin by a process such as extrusion, prior to the polymer's incorporation into the polymeric composition.

In examples where the silane-functionalized polyolefin is an α-olefin and silane copolymer, the silane-functionalized polyolefin is prepared by the copolymerization of at least one α-olefin and a hydrolyzable silane monomer. In examples where the silane-functionalized polyolefin is a silane grafted polyolefin, the silane-functionalized polyolefin is prepared by grafting one or more hydrolyzable silane monomers on to the polymerized α-olefin backbone of a polymer.

The silane-functionalized polyolefin may comprise 50 wt % or greater, 60 wt % or greater, 70 wt % or greater, 80 wt % or greater, 85 wt % or greater, 90 wt % or greater, or 91 wt % or greater, or 92 wt % or greater, or 93 wt % or greater, or 94 wt % or greater, or 95 wt % or greater, or 96 wt % or greater, or 97 wt % or greater, or 97.5 wt % or greater, or 98 wt % or greater, or 99 wt % or greater, while at the same time, 99.5 wt % or less, or 99 wt % or less, or 98 wt % or less, or 97 wt % or less, or 96 wt % or less, or 95 wt % or less, or 94 wt % or less, or 93 wt % or less, or 92 wt % or less, or 91 wt % or less, or 90 wt % or less, or 85 wt % or less, or 80 wt % or less, or 70 wt % or less, or 60 wt % or less of α-olefin as measured using Nuclear Magnetic Resonance (NMR) or Fourier-Transform Infrared (FTIR) Spectroscopy. The α-olefin may include C₂, or C₃ to C₄, or C₆, or C₈, or C₁₀, or C₁₂, or C₁₆, or C₁₈, or C₂₀ α-olefins, such as ethylene, propylene, 1-butene, 1-hexene, 4-methyl-1-pentene, and 1-octene. Other units of the silane-functionalized polyolefin may be derived from one or more polymerizable monomers including, but not limited to, unsaturated esters. The unsaturated esters may be alkyl acrylates, alkyl methacrylates, or vinyl carboxylates. The alkyl groups can have from 1 to 8 carbon atoms, or from 1 to 4 carbon atoms. The carboxylate groups can have from 2 to 8 carbon atoms, or from 2 to 5 carbon atoms. Examples of acrylates and methacrylates include, but are not limited to, ethyl acrylate, methyl acrylate, methyl methacrylate, t-butyl acrylate, n-butyl acrylate, n-butyl methacrylate, and 2 ethylhexyl acrylate. Examples of vinyl carboxylates include, but are not limited to, vinyl acetate, vinyl propionate, and vinyl butanoate.

The silane-functionalized polyolefin has a density of 0.860 grams per cubic centimeter (g/cc) or greater, or 0.870 g/cc or greater, or 0.880 g/cc or greater, or 0.890 g/cc or greater, or 0.900 g/cc or greater, or 0.910 g/cc or greater, or 0.915 g/cc or greater, or 0.920 g/cc or greater, or 0.921 g/cc or greater, or 0.922 g/cc or greater, or 0.925 g/cc to 0.930 g/cc or greater, or 0.935 g/cc or greater, while at the same time, 0.970 g/cc or less, or 0.960 g/cc or less, or 0.950 g/cc or less, or 0.940 g/cc or less, or 0.935 g/cc or less, or 0.930 g/cc or less, or 0.925 g/cc or less, or 0.920 g/cc or less, or 0.915 g/cc or less as measured by ASTM D792.

A “hydrolyzable silane monomer” is a silane-containing monomer that will effectively copolymerize with an α-olefin (e.g., ethylene) to form an α-olefin/silane copolymer (such as an ethylene/silane copolymer), or graft to an α-olefin polymer (i.e., a polyolefin) to form a Si-g-polyolefin, thus enabling subsequent crosslinking of the silane-functionalized polyolefin. A representative, but not limiting, example of a hydrolyzable silane monomer has structure (I):

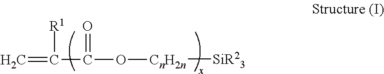

in which R¹ is a hydrogen atom or methyl group; x is 0 or 1; n is an integer from 1 to 4, or 6, or 8, or 10, or 12; and each R² independently is a hydrolyzable organic group such as an alkoxy group having from 1 to 12 carbon atoms (e.g., methoxy, ethoxy, butoxy), an aryloxy group (e.g., phenoxy), an araloxy group (e.g., benzyloxy), an aliphatic acyloxy group having from 1 to 12 carbon atoms (e.g., formyloxy, acetyloxy, propanoyloxy), an amino or substituted amino group (e.g., alkylamino, arylamino), or a lower-alkyl group having 1 to 6 carbon atoms, with the proviso that not more than one of the three R² groups is an alkyl. The hydrolyzable silane monomer may be copolymerized with an α-olefin (such as ethylene) in a reactor, such as a high-pressure process, to form an α-olefin/silane copolymer. In examples where the α-olefin is ethylene, such a copolymer is referred to herein as an ethylene/silane copolymer. The hydrolyzable silane monomer may also be grafted to a polyolefin (such as a polyethylene) by the use of an organic peroxide, such as 2,5-bis(tert-butylperoxy)-2,5-dimethylhexane, to form a Si-g-PO or an in-situ Si-g-PO. The in-situ Si-g-PO is formed by a process such as the MONOSIL process, in which a hydrolyzable silane monomer is grafted onto the backbone of a polyolefin during the extrusion of the present composition to form a coated conductor, as described, for example, in U.S. Pat. No. 4,574,133.

The hydrolyzable silane monomer may include silane monomers that comprise an ethylenically unsaturated hydrocarbyl group, such as a vinyl, allyl, isopropenyl, butenyl, cyclohexenyl or gamma (meth)acryloxy allyl group, and a hydrolyzable group, such as, for example, a hydrocarbyloxy, hydrocarbonyloxy, or hydrocarbylamino group. Hydrolyzable groups may include methoxy, ethoxy, formyloxy, acetoxy, proprionyloxy, and alkyl or arylamino groups. In a specific example, the hydrolyzable silane monomer is an unsaturated alkoxy silane, which can be grafted onto the polyolefin or copolymerized in-reactor with an α-olefin (such as ethylene). Examples of hydrolyzable silane monomers include vinyltrimethoxysilane (VTMS), vinyltriethoxysilane (VTES), vinyltriacetoxysilane, and gamma-(meth)acryloxy propyl trimethoxy silane. In context to Structure (I), for VTMS: x=0; R¹=hydrogen; and R²=methoxy; for VTES: x=0; R¹=hydrogen; and R²=ethoxy; and for vinyltriacetoxysilane: x=0; R¹=H; and R²=acetoxy.

Examples of suitable ethylene/silane copolymers are commercially available as SI-LINK™ DFDA-5451 NT and SI-LINK™ AC DFDB-5451 NT, each available from The Dow Chemical Company, Midland, Mich. Examples of suitable Si-g-PO are commercially available as PEXIDAN™ A-3001 from SACO AEI Polymers, Shebyogan, Wis. and SYNCURE™ S1054A from PolyOne, Avon Lake, Ohio.

The polymeric composition may comprise from 20 wt % to 80 wt % of silane-functionalized polyolefin. The polymeric composition may comprise 20 wt % or greater, or 22 wt % or greater, or 24 wt % or greater, or 26 wt % or greater, or 28 wt % or greater, or 30 wt % or greater, or 32 wt % or greater, or 34 wt % or greater, or 36 wt % or greater, or 38 wt % or greater, or 40 wt % or greater, or 42 wt % or greater, or 44 wt % or greater, or 46 wt % or greater, or 48 wt % or greater, or 50 wt % or greater, or 52 wt % or greater, or 54 wt % or greater, or 56 wt % or greater, or 58 wt % or greater, or 60 wt % or greater, or 65 wt % or greater, or 70 wt % or greater, or 75 wt % or greater, while at the same time, 80 wt % or less, or 75 wt % or less, or 70 wt % or less, or 65 wt % or less, or 60 wt % or less, or 58 wt % or less, or 56 wt % or less, or 54 wt % or less, or 52 wt % or less, or 40 wt % or less, or 48 wt % or less, or 46 wt % or less, or 44 wt % or less, or 42 wt % or less, or 40 wt % or less, or 38 wt % or less, or 36 wt % or less, or 34 wt % or less, or 32 wt % or less, or 30 wt % or less, or 28 wt % or less, or 26 wt % or less, or 24 wt % or less, or 22 wt % or less of silane-functionalized polyolefin based on a total weight of the polymeric composition.

The silane-functionalized polyolefin has a melt index as measured according to ASTM D1238 under the conditions of 190° C./2.16 kilogram (kg) weight and is reported in grams eluted per 10 minutes (g/10 min). The melt index of the silane functionalized polyolefin may be 0.5 g/10 min or greater, or 1.0 g/10 min or greater, or 1.5 g/10 min or greater, or 2.0 g/10 min or greater, or 2.5 g/10 min or greater, or 3.0 g/10 min or greater, or 3.5 g/10 min or greater, or 4.0 g/10 min or greater, or 4.5 g/10 min or greater, while at the same time, 30.0 g/10 min or less, or 25.0 g/10 min or less, or 20.0 g/10 min or less, or 15.0 g/10 min or less, or 10.0 g/10 min or less, or 5.0 g/10 min or less, or 4.5 g/10 min or less, or 4.0 g/10 min or less, or 3.5 g/10 min or less, or 3.0 g/10 min or less, or 2.5 g/10 min or less, or 2.0 g/10 min or less, or 1.5 g/10 min or less, or 1.0 g/10 min or less.

### Brominated Flame Retardant

The polymeric composition comprises a brominated flame retardant. The brominated flame retardant may have a Temperature of 5% Mass Loss from 350° C. to 500° C. as measured according to Thermogravimetric Analysis as explained below. The Temperature of 5% Mass Loss may be 350° C. or greater, or 360° C. or greater, or 370° C. or greater, or 380° C. or greater, or 390° C. or greater, or 400° C. or greater, or 410° C. or greater, or 420° C. or greater, or 430° C. or greater, or 440° C. or greater, or 450° C. or greater, or 460° C. or greater, or 470° C. or greater, or 480° C. or greater, or 490° C. or greater, while at the same time, 500° C. or less, or 490° C. or less, or 480° C. or less, or 470° C. or less, or 460° C. or less, or 450° C. or less, or 440° C. or less, or 430° C. or less, or 420° C. or less, or 410° C. or less, or 400° C. or less, or 390° C. or less, or 380° C. or less, or 370° C. or less, or 360° C. or less as measured according to Thermogravimetric Analysis. The Temperature of 5% Mass Loss is correlated with dehydrobromination of the brominated flame retardant. Premature dehydrobromination negatively affects the flame retardancy, as does too late dehydrobromination, and as such having a Temperature of 5% Mass Loss from 350° C. to 500° C. is advantageous in increasing flame retardancy.

The brominated flame retardant has a Retained Mass at 650° C. of 2 wt % to 50 wt % as measured according to Thermogravimetric Analysis as explained below. The brominated flame retardant may have a Retained Mass at 650° C. of 2 wt % or greater, or 5 wt % or greater, or 10 wt % or greater, or 13 wt % or greater, or 15 wt % or greater, or 18 wt % or greater, or 20 wt % or greater, or 25 wt % or greater, or 30 wt % or greater, or 35 wt % or greater, or 40 wt % or greater, or 45 wt % or greater, while at the same time, 50 wt % or less, or 45 wt % or less, or 40 wt % or less, or 35 wt % or less, or 30 wt % or less, or 25 wt % or less, or 20 wt % or less, or 18 wt % or less, or 15 wt % or less, or 13 wt % or less, or 10 wt % or less, or 5 wt % or less. The Retained Mass at 650° C. is an indication of the brominated flame retardant's sole ability to form char, which is often a carbonaceous material that insulates the material being protected, slowing pyrolysis and creating a barrier that hinders diffusion of oxygen/air as well as the release of additional gases to fuel combustion. Thus, in terms of the well-known fire triangle, the formation of char is advantageous as it both reduces heat transmission in addition to reducing oxygen contact with the polymeric composition.

The brominated flame retardant may comprise ethylene bis-tetrabromophthalimide. Ethylene bis-tetrabromophthalimide has a CAS number of 32588-76-4 and is commercially available under the tradename SAYTEX™ BT-93W from Albemarle, Charlotte, N.C., USA. The polymeric composition may comprise 5 wt % or greater, 10 wt % or greater, 11 wt % or greater, or 13 wt % or greater, or 15 wt % or greater, or 20 wt % or greater, or 25 wt % or greater, or 30 wt % or greater, or 31 wt % or greater, or 32 wt % or greater, or 33 wt % or greater, or 34 wt % or greater, or 35 wt % or greater, or 36 wt % or greater, or 37 wt % or greater, or 38 wt % or greater, or 39 wt % or greater, or 40 wt % or greater, or 41 wt % or greater, or 42 wt % or greater, or 43 wt % or greater, or 44 wt % or greater, while at the same time, 45 wt % or less, or 44 wt % or less, or 43 wt % or less, or 42 wt % or less, or 41 wt % or less, or 40 wt % or less, or 39 wt % or less, or 38 wt % or less, or 37 wt % or less, or 36 wt % or less, or 35 wt % or less, or 34 wt % or less, or 33 wt % or less, or 32 wt % or less, or 31 wt % or less, or 30 wt % or less, or 25 wt % or less, or 20 wt % or less, or 15 wt % or less, or 13 wt % or less, or 11 wt % or less, or 10 wt % or less of ethylene bis-tetrabromophthalimide based on a total weight of the polymeric composition. Ethylene bis-tetrabromophthalimide has a bromine content of 67.2 wt %.

### Antimony Trioxide

The polymeric composition comprises antimony trioxide. Antimony trioxide (Sb₂O₃) has the CAS number 1309-64-4 and the following Structure (II):

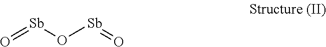

Antimony trioxide has a molecular weight (Mw) of 291.518 grams per mole (g/mol). One gram of antimony trioxide (Sb₂O₃) contains 0.835345774 grams antimony (Sb). Antimony trioxide is commercially available under the tradename MICROFINE™ AO9 from Great Lakes Solution, and BRIGHTSUN™ HB from China Antimony Chemicals Co., Ltd. The polymeric composition may comprise 1 wt % or greater, or 2 wt % or greater, or 3 wt % or greater, or 4 wt % or greater, or 5 wt % or greater, or 6 wt % or greater, or 7 wt % or greater, or 8 wt % or greater, or 9 wt % or greater, or 10 wt % or greater, or 11 wt % or greater, or 12 wt % or greater, or 13 wt % or greater, or 14 wt % or greater, while at the same time, 15 wt % or less, or 14 wt % or less, or 13 wt % or less, or 12 wt % or less, or 11 wt % or less, or 10 wt % or less, or 9 wt % or less, or 8 wt % or less, or 7 wt % or less, or 6 wt % or less, or 5 wt % or less, or 4 wt % or less, or 3 wt % or less, or 2 wt % or less of the antimony trioxide.

### Second Polyolefin

The polymeric composition may include an optional second polyolefin. As with the silane functionalized polyolefin, the second olefin comprises polymerized α-olefins and optionally unsaturated esters. The α-olefin may include C₂, or C₃ to C₄, or C₆, or C₈, or C₁₀, or C₁₂, or C₁₆, or C₁₈, or C₂₀ α-olefins, such as ethylene, propylene, 1-butene, 1-hexene, 4-methyl-1-pentene, and 1-octene. The unsaturated esters can be alkyl acrylates, alkyl methacrylates, or vinyl carboxylates. The second polyolefin may not be silane functionalized. The second polyolefin may have a crystallinity at 23° C. from 0 wt % to 80 wt % as measured according to Crystallinity Testing as provided below. For example, the crystallinity at 23° C. of the second polyolefin may be 0 wt % or greater, or 5 wt % or greater, or 10 wt % or greater, or 15 wt % or greater, or 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, while at the same time, 80 wt % or less, or 75 wt % or less, or 70 wt % or less, or 65 wt % or less, or 60 wt % or less, or 55 wt % or less, or 50 wt % or less, or 45 wt % or less, or 40 wt % or less, or 35 wt % or less, or 30 wt % or less, or 25 wt % or less, or 20 wt % or less, or 15 wt % or less, or 10 wt % or less as measured according to Crystallinity Testing.

The second polyolefin may be an ultra-low-density polyethylene or a linear low-density polyethylene or a high density polyethylene or an ethylene ethyl acrylate copolymer or an ethylene vinyl acetate copolymer. The density of the second polyolefin may be 0.860 g/cc or greater, 0.870 g/cc or greater, or 0.880 g/cc or greater, or 0.890 g/cc or greater, or 0.900 g/cc or greater, or 0.904 g/cc or greater, or 0.910 g/cc or greater, or 0.915 g/cc or greater, or 0.920 g/cc or greater, or 0.921 g/cc or greater, or 0.922 g/cc or greater, or 0.925 g/cc to 0.930 g/cc or greater, or 0.935 g/cc or greater, while at the same time, 0.970 g/cc or less, or 0.960 g/cc or less, or 0.950 g/cc or less, or 0.940 g/cc or less, or 0.935 g/cc or less, or 0.930 g/cc or less, or 0.925 g/cc or less, or 0.920 g/cc or less, or 0.915 g/cc or less, or 0.910 g/cc or less, or 0.905 g/cc or less, or 0.900 g/cc or less as measured by ASTM D792.

The second polyolefin has a melt index as measured according to ASTM D1238 under the conditions of 190° C./2.16 kilogram (kg) weight and is reported in grams eluted per 10 minutes (g/10 min). The melt index of the silane functionalized polyolefin may be 0.5 g/10 min or greater, or 1.0 g/10 min or greater, or 1.5 g/10 min or greater, or 2.0 g/10 min or greater, or 2.5 g/10 min or greater, or 3.0 g/10 min or greater, or 3.5 g/10 min or greater, or 4.0 g/10 min or greater, or 4.5 g/10 min or greater, while at the same time, 30.0 g/10 min or less, or 25.0 g/10 min or less, or 20.0 g/10 min or less, or 15.0 g/10 min or less, or 10.0 g/10 min or less, or 5.0 g/10 min or less, or 4.5 g/10 min or less, or 4.0 g/10 min or less, or 3.5 g/10 min or less, or 3.0 g/10 min or less, or 2.5 g/10 min or less, or 2.0 g/10 min or less, or 1.5 g/10 min or less, or 1.0 g/10 min or less.

The polymeric composition may comprise from 0 wt % to 30 wt % of second polyolefin based on the total weight of the polymeric composition. The polymeric composition may comprise 0 wt % or greater, or 5 wt % or greater, or 10 wt % or greater, or 15 wt % or greater, or 20 wt % or greater, or 25 wt % or greater, while at the same time, 30 wt % or less, or 25 wt % or less, or 20 wt % or less, or 15 wt % or less, or 10 wt % of the second polyolefin.

### Additives

The polymeric composition may include one or more additives. Nonlimiting examples of suitable additives include antioxidants, colorants, corrosion inhibitors, lubricants, silanol condensation catalysts, ultraviolet (UV) absorbers or stabilizers, anti-blocking agents, flame retardants, coupling agents, compatibilizers, plasticizers, fillers, processing aids, and combinations thereof.

The polymeric composition may include an antioxidant. Nonlimiting examples of suitable antioxidants include phenolic antioxidants, thio-based antioxidants, phosphate-based antioxidants, and hydrazine-based metal deactivators. Suitable phenolic antioxidants include high molecular weight hindered phenols, methyl-substituted phenol, phenols having substituents with primary or secondary carbonyls, and multifunctional phenols such as sulfur and phosphorous-containing phenol. Representative hindered phenols include 1,3,5-trimethyl-2,4,6-tris-(3,5-di-tert-butyl-4-hydroxybenzyl)-benzene; pentaerythrityl tetrakis-3(3,5-di-tert-butyl-4-hydroxyphenyl)-propionate; n-octadecyl-3(3,5-di-tert-butyl-4-hydroxyphenyl)-propionate; 4,4′-methylenebis(2,6-tert-butyl-phenol); 4,4′-thiobis(6-tert-butyl-o-cresol); 2,6-di-tertbutylphenol; 6-(4-hydroxyphenoxy)-2,4-bis(n-octyl-thio)-1,3,5 triazine; di-n-octylthio)ethyl 3,5-di-tert-butyl-4-hydroxy-benzoate; and sorbitol hexa[3-(3,5-di-tert-butyl-4-hydroxy-phenyl)-propionate]. In an embodiment, the composition includes pentaerythritol tetrakis(3-(3,5-di-tert-butyl-4-hydroxyphenyl)propionate), commercially available as Irganox™ 1010 from BASF. A nonlimiting example of a suitable methyl-substituted phenol is isobutylidenebis(4,6-dimethylphenol). A nonlimiting example of a suitable hydrazine-based metal deactivator is oxalyl bis(benzylidiene hydrazide). In an embodiment, the composition contains from 0 wt %, or 0.001 wt %, or 0.01 wt %, or 0.02 wt %, or 0.05 wt %, or 0.1 wt %, or 0.2 wt %, or 0.3 wt %, or 0.4 wt % to 0.5 wt %, or 0.6 wt %, or 0.7 wt %, or 0.8 wt %, or 1.0 wt %, or 2.0 wt %, or 2.5 wt %, or 3.0 wt % antioxidant, based on total weight of the composition.

The polymeric composition may include a silanol condensation catalyst, such as Lewis and Brønsted acids and bases. A “silanol condensation catalyst” promotes crosslinking of the silane functionalized polyolefin through hydrolysis and condensation reactions. Lewis acids are chemical species that can accept an electron pair from a Lewis base. Lewis bases are chemical species that can donate an electron pair to a Lewis acid. Nonlimiting examples of suitable Lewis acids include the tin carboxylates such as dibutyl tin dilaurate (DBTDL), dimethyl hydroxy tin oleate, dioctyl tin maleate, di-n-butyl tin maleate, dibutyl tin diacetate, dibutyl tin dioctoate, stannous acetate, stannous octoate, and various other organo-metal compounds such as lead naphthenate, zinc caprylate and cobalt naphthenate. Nonlimiting examples of suitable Lewis bases include the primary, secondary and tertiary amines. Nonlimiting examples of suitable Brønsted acids are methanesulfonic acid, benzenesulfonic acid, dodecylbenzenesulfonic acid, naphthalenesulfonic acid, or an alkylnaphthalenesulfonic acid. The silanol condensation catalyst may comprise a blocked sulfonic acid. The blocked sulfonic acid may be as defined in US 2016/0251535 A1 and may be a compound that generates in-situ a sulfonic acid upon heating thereof, optionally in the presence of moisture or an alcohol. Examples of blocked sulfonic acids include amine-sulfonic acid salts and sulfonic acid alkyl esters. The blocked sulfonic acid may consist of carbon atoms, hydrogen atoms, one sulfur atom, and three oxygen atoms, and optionally a nitrogen atom. These catalysts are typically used in moisture cure applications. The polymeric composition includes from 0 wt %, or 0.001 wt %, or 0.005 wt %, or 0.01 wt %, or 0.02 wt %, or 0.03 wt % to 0.05 wt %, or 0.1 wt %, or 0.2 wt %, or 0.5 wt %, or 1.0 wt %, or 3.0 wt %, or 5.0 wt % silanol condensation catalyst, based on the total weight of the composition. The silanol condensation catalyst is typically added to the article manufacturing-extruder (such as during cable manufacture) so that it is present during the final melt extrusion process. As such, the silane functionalized polyolefin may experience some crosslinking before it leaves the extruder with the completion of the crosslinking after it has left the extruder, typically upon exposure to moisture (e.g., a sauna, hot water bath or a cooling bath) and/or the humidity present in the environment in which it is stored, transported or used.

The silanol condensation catalyst may be included in a catalyst masterbatch blend with the catalyst masterbatch being included in the composition. Nonlimiting examples of suitable catalyst masterbatches include those sold under the trade name SI-LINK™ from The Dow Chemical Company, including SI-LINK™ DFDA-5481 Natural and SI-LINK™ AC DFDA-5488 NT. In an embodiment, the composition contains from 0 wt %, or 0.001 wt %, or 0.01 wt %, or 0.5 wt %, or 1.0 wt %, or 2.0 wt %, or 3.0 wt %, or 4.0 wt % to 5.0 wt %, or 6.0 wt %, or 7.0 wt %, or 8.0 wt %, or 9.0 wt %, or 10.0 wt %, or 15.0 wt %, or 20.0 wt % catalyst masterbatch, based on total weight of the composition.

The polymeric composition may include an ultraviolet (UV) absorber or stabilizer. A nonlimiting example of a suitable UV stabilizer is a hindered amine light stabilizer (HALS). A nonlimiting example of a suitable HALS is 1,3,5-Triazine-2,4,6-triamine, N,N-1,2-ethanediylbisN-3-4,6-bisbutyl(1,2,2,6,6-pentamethyl-4-piperidinyl)amino-1,3,5-triazin-2-ylaminopropyl-N,N-dibutyl-N,N-bis(1,2,2,6,6-pentamethyl-4-piperidinyl)-1,5,8,12-tetrakis[4,6-bis(n-butyl-n-1,2,2,6,6-pentamethyl-4-piperidylamino)-1,3,5-triazin-2-yl]-1,5,8,12-tetraazadodecane, which is commercially available as SABO™ STAB UV-119 from SABO S.p.A. of Levate, Italy. In an embodiment, the composition contains from 0 wt %, or 0.001 wt %, or 0.002 wt %, or 0.005 wt %, or 0.006 wt % to 0.007 wt %, or 0.008 wt %, or 0.009 wt %, or 0.01 wt %, or 0.2 wt %, or 0.3 wt %, or 0.4 wt %, or 0.5 wt %, 1.0 wt %, or 2.0 wt %, or 2.5 wt %, or 3.0 wt % UV absorber or stabilizer, based on total weight of the composition.

The polymeric composition includes a filler. Nonlimiting examples of suitable fillers include zinc oxide, zinc borate, zinc molybdate, zinc sulfide, carbon black, organo-clay, aluminum trihydroxide, magnesium hydroxide, calcium carbonate, hydromagnesite, huntite, hydrotalcite, boehmite, magnesium carbonate, magnesium phosphate, calcium hydroxide, calcium sulfate, silica, silicone gum, talc and combinations thereof. The filler may or may not have flame retardant properties. In an embodiment, the filler is coated with a material that will prevent or retard any tendency that the filler might otherwise have to interfere with the silane cure reaction. Stearic acid is illustrative of such a filler coating. In an embodiment, the composition contains from 0 wt %, or 0.01 wt %, or 0.02 wt %, or 0.05 wt %, or 0.07 wt %, or 0.1 wt %, or 0.2 wt %, or 0.3 wt %, or 0.4 wt % to 0.5 wt %, or 0.6 wt %, or 0.7 wt %, or 0.8 wt %, or 1.0 wt %, or 2.0 wt %, or 2.5 wt %, or 3.0 wt %, or 5.0 wt %, or 8.0 wt %, or 10.0 wt %, or 20 wt % filler, based on total weight of the polymeric composition.

In an embodiment, the composition includes a processing aid. Nonlimiting examples of suitable processing aids include oils, polydimethylsiloxane, organic acids (such as stearic acid), and metal salts of organic acids (such as zinc stearate). In an embodiment, the composition contains from 0 wt %, or 0.01 wt %, or 0.02 wt %, or 0.05 wt %, or 0.07 wt %, or 0.1 wt %, or 0.2 wt %, or 0.3 wt %, or 0.4 wt % to 0.5 wt %, or 0.6 wt %, or 0.7 wt %, or 0.8 wt %, or 1.0 wt %, or 2.0 wt %, or 2.5 wt %, or 3.0 wt %, or 5.0 wt %, or 10.0 wt % processing aid, based on total weight of the composition.

In an embodiment, the composition contains from 0 wt %, or greater than 0 wt %, or 0.001 wt %, or 0.002 wt %, or 0.005 wt %, or 0.006 wt % to 0.007 wt %, or 0.008 wt %, or 0.009 wt %, or 0.01 wt %, or 0.2 wt %, or 0.3 wt %, or 0.4 wt %, or 0.5 wt %, 1.0 wt %, or 2.0 wt %, or 2.5 wt %, or 3.0 wt %, or 4.0 wt %, or 5.0 wt % to 6.0 wt %, or 7.0 wt %, or 8.0 wt %, or 9.0 wt %, or 10.0 wt %, or 15.0 wt %, or 20.0 wt %, or 30 wt %, or 40 wt %, or 50 wt % additive, based on the total weight of the composition.

One or more of the brominated flame retardant, antimony trioxide and the additives may be combined as a pre-mixed masterbatch. Such masterbatches are commonly formed by dispersing the brominated flame retardant, antimony trioxide and/or additives into an inert plastic resin, e.g., a low density polyethylene. Masterbatches are conveniently formed by melt compounding methods.

One or more of the components or masterbatches may be dried before compounding or extrusion, or a mixture of components or masterbatches is dried after compounding or extrusion, to reduce or eliminate potential scorch that may be caused from moisture present in or associated with the component, e.g., filler. The compositions may be prepared in the absence of a silanol condensation catalyst for extended shelf life, and the silanol condensation catalyst may be added as a final step in the preparation of a cable construction by extrusion processes.

### Sb:Br Molar ratio

The polymeric composition contains antimony trioxide and brominated flame retardant in such relative quantities that the antimony (Sb) and bromine (Br) is at a molar ratio (Sb:Br molar ratio) from greater than 0.0 to 0.35. For example, the polymeric composition has a Sb:Br molar ratio of greater than 0.0, or 0.02 or greater, or 0.04 or greater, or 0.06 or greater, or 0.08 or greater, or 0.10 or greater, or 0.12 or greater, or 0.14 or greater, or 0.16 or greater, or 0.18 or greater, or 0.20 or greater, or 0.22 or greater, or 0.24 or greater, or 0.26 or greater, or 0.28 or greater, or 0.30 or greater, or 0.32 or greater, or 0.34 or greater, while at the same time, 0.36 or less, or 0.34 or less, or 0.32 or less, or 0.30 or less, or 0.28 or less, or 0.26 or less, or 0.24 or less, or 0.22 or less, or 0.20 or less, or 0.18 or less, or 0.16 or less, or 0.14 or less, or 0.12 or less, or 0.10 or less, or 0.08 or less, or 0.06 or less, or 0.04 or less, or 0.02 or less. The Sb:Br molar ratio is calculated in accordance with the following Equation (1):

$$Sb : Br molar ratio = \frac{moles of antimony in polymeric composition}{moles of bromine in polymeric composition} \qquad Eq . ( 1 )$$

The number of moles of antimony (Sb) in the polymeric composition from the antimony trioxide (Sb₂O₃) is calculated in accordance with the following Equation (1A):

$$moles of antimony in polymeric composition = \frac{( grams {Sb}_{2} {O}_{3} in composition \times 0.835345774 )}{121.76} . \qquad Eq ( 1 A )$$

The number of moles of bromine in the polymeric composition from the brominated flame retardant is calculated in accordance with the following Equation (1B):

$$moles of bromine in polymeric composition = \frac{( grams of bromine in composition )}{79.904} . \qquad Eq . ( 1 B )$$

### Coated Conductor

The present disclosure also provides a coated conductor. The coated conductor includes a conductor and a coating on the conductor, the coating including the polymeric composition. The polymeric composition is at least partially disposed around the conductor to produce the coated conductor.

The process for producing a coated conductor includes mixing and heating the polymeric composition to at least the melting temperature of the silane functionalized polyolefin in an extruder, and then coating the polymeric melt blend onto the conductor. The term “onto” includes direct contact or indirect contact between the polymeric melt blend and the conductor. The polymeric melt blend is in an extrudable state.

The polymeric composition is disposed around on and/or around the conductor to form a coating. The coating may be one or more inner layers such as an insulating layer. The coating may wholly or partially cover or otherwise surround or encase the conductor. The coating may be the sole component surrounding the conductor. Alternatively, the coating may be one layer of a multilayer jacket or sheath encasing the metal conductor. The coating may directly contact the conductor. The coating may directly contact an insulation layer surrounding the conductor.

The resulting coated conductor (cable) is cured at humid conditions for a sufficient length of time such that the coating reaches a desired degree of crosslinking. The temperature during cure is generally above 0° C. In an embodiment, the cable is cured (aged) for at least 4 hours in a 90° C. water bath. In an embodiment, the cable is cured (aged) for up to 30 days at ambient conditions comprising an air atmosphere, ambient temperature (e.g., 20° C. to 40° C.), and ambient relative humidity (e.g., 10 to 96 percent relative humidity (% RH)).

The coated conductor may pass the horizontal burn test. To pass the horizontal burn test, the coated conductor must have a total char of less than 100 mm and the cotton placed underneath must not ignite. A time to self-extinguish of less than 80 seconds is desirable. The coated conductor may have a total char during the horizontal burn test from 0 mm, or 5 mm, or 10 mm to 50 mm, or 55 mm, or 60 mm, or 70 mm, or 75 mm, or 80 mm, or 90 mm, or less than 100 mm. The coated conductor may have a time to self-extinguish during the horizontal burn test from 0 seconds, or 5 seconds, or 10 seconds to 30 seconds, or 35 seconds, or 40 seconds, or 50 seconds, or 60 seconds, or 70 seconds, or less than 80 seconds.

The coated conductor may pass the VW-1 test. To pass the VW-1 test and thus have a VW-1 rating, the coated conductor must self-extinguish within 60 seconds (≤60 seconds) of the removal of a burner for each of five 15 second flame impingement cycles, exhibit less than or equal to 25% flag burn, and exhibit no cotton burn. The VW-1 test is more stringent than the horizontal burn test. In an embodiment, the coated conductor has a time to self-extinguish during the VW-1 test from 0 seconds to 20 seconds, or 30 seconds, or 40 seconds, or 50 seconds, or 60 seconds, or less than 60 seconds during each of the 5 individual cycles. In an embodiment, the coated conductor has a no char to flag length during the VW-1 test from 20 mm, or 40 mm, or 50 mm, or 75 mm to 100 mm, or 110 mm, or 120 mm, or 130 mm, or 140 mm, or 150 mm, or 160 mm, or 180 mm, or 200 mm, or 250 mm, or 300 mm, or 350 mm, or 400 mm, or 500 mm, or 508 mm.

The coated conductor has one, some, or all of the following properties: (i) a total char during the horizontal burn test from 0 mm to less than 100 mm; (ii) a time to self-extinguish during the horizontal burn test from 0 seconds to less than 80 seconds; (iii) a time to self-extinguish during the VW-1 test from 0 seconds to less than 60 seconds during each of the 5 individual cycles. The coated conductor may pass the horizontal burn test and/or the VW-1 burn test.

### EXAMPLES

### Test Methods

Density: Density is measured in accordance with ASTM D792, Method B. The result is recorded in grams (g) per cubic centimeter (g/cc).

Melt Index: Melt index (MI) is measured in accordance with ASTM D1238, Condition 190° C./2.16 kilogram (kg) weight and is reported in grams eluted per 10 minutes (g/10 min).

Thermogravimetric Analysis: Thermogravimetric Analysis testing is performed using a Q5000 thermogravimetric analyzer from TA INSTRUMENTS™. Perform Thermogravimetric Analysis testing by placing a sample of the material in the thermogravimetric analyzer on platinum pans under nitrogen at flow rate of 100 cm³/minute and, after equilibrating at 40° C., raising the temperature from 40° C. to 650° C. at a rate of 20° C./minute while measuring the mass of the sample. From the curve of data generated associating a temperature with a % of mass remaining, determine the temperature at which 5% of the mass of the sample was lost to get the Temperature of 5% Mass Loss. From the curve of data generated associating a temperature with a % of mass remaining, determine the mass% of the sample remaining when the Thermogravimetric Analysis reaches 650° C. to get the Retained Mass at 650° C.

Crystallinity Testing: determine melting peaks and percent (%) or weight percent (wt %) crystallinity of ethylene-based polymers at 23° C. using Differential Scanning Calorimeter (DSC) instrument DSC Q1000 (TA Instruments). (A) Baseline calibrate DSC instrument. Use software calibration wizard. Obtain a baseline by heating a cell from −80° to 280° C. without any sample in an aluminum DSC pan. Then use sapphire standards as instructed by the calibration wizard. Analyze 1 to 2 milligrams (mg) of a fresh indium sample by heating the standards sample to 180° C., cooling to 120° C. at a cooling rate of 10° C./minute, then keeping the standards sample isothermally at 120° C. for 1 minute, followed by heating the standards sample from 120° C. to 180° C. at a heating rate of 10° C./minute. Determine that indium standards sample has heat of fusion=28.71±0.50 Joules per gram (J/g) and onset of melting=156.6°±0.5° C. (B) Perform DSC measurements on test samples using the baseline calibrated DSC instrument. Press test sample of semi-crystalline ethylenic polymer into a thin film at a temperature of 160° C. Weigh 5 to 8 mg of test sample film in aluminum DSC pan. Crimp lid on pan to seal pan and ensure closed atmosphere. Place lid-sealed pan in DSC cell, equilibrate cell at 30° C., and then heat at a rate of about 100° C./minute to 190° C., keep sample at 190° C. for 3 minutes, cool sample at a rate of 10° C./minute to −60° C. to obtain a cool curve heat of fusion (H_{f}), and keep isothermally at −60° C. for 3 minutes. Then heat sample again at a rate of 10° C./minute to 190° C. to obtain a second heating curve heat of fusion (ΔH_{f}). Using the second heating curve, calculate the “total” heat of fusion (J/g) by integrating from −20° C. (in the case of ethylene homopolymers, copolymers of ethylene and hydrolysable silane monomers, and ethylene alpha olefin copolymers of density greater than or equal to 0.90g/cm³) or −40° C. (in the case of copolymers of ethylene and unsaturated esters, and ethylene alpha olefin copolymers of density less than 0.90g/cm³) to end of melting. Using the second heating curve, calculate the “room temperature” heat of fusion (J/g) from 23° C. (room temperature) to end of melting by dropping perpendicular at 23° C. Measure and report “total crystallinity” (computed from “total” heat of fusion) as well as “Crystallinity at room temperature” (computed from 23° C. heat of fusion). Crystallinity is measured and reported as percent (%) or weight percent (wt %) crystallinity of the polymer from the test sample's second heating curve heat of fusion (ΔH_{f}) and its normalization to the heat of fusion of 100% crystalline polyethylene, where % crystallinity or wt % crystallinity=(ΔH_{f}*100%)/292 J/g, wherein ΔH_{f} is as defined above, * indicates mathematical multiplication, / indicates mathematical division, and 292 J/g is a literature value of heat of fusion (ΔH_{f}) for a 100% crystalline polyethylene.

VW-1 Burn Test: The VW-1 Burn Test is conducted by subjecting three or five samples of a specific coated conductor to the protocol of UL 2556 Section 9.4. This involves five 15-second applications of a 125 mm flame impinging on at an angle 20° on a vertically oriented specimen 610 mm (24 in) in length. A strip of kraft paper 12.5±1 mm (0.5±0.1 in) is affixed to the specimen 254±2 mm (10±0.1 in) above the impingement point of the flame. A continuous horizontal layer of cotton is placed on the floor of the test chamber, centered on the vertical axis of the test specimen, with the upper surface of the cotton being 235±6 mm (9.25±0.25 in) below the point at which the tip of the blue inner cone of the flame impinges on the specimen. Test failure is based upon the criteria of either burning the 25% of the kraft paper tape flag, ignition of the cotton batting or if the specimen burns longer than 60 seconds on any of the five flame applications. As an additional measure of burn performance, the length of uncharred insulation (“no char to flag length”) is measured at the completion of the test. The self-extinguishment time of the 3-5 specimens and 5 cycles is averaged to determine the “VW-1 Average Time to Self-Extinguish” provided in Table 2. The VW-1 cotton ignited indicates if falling material ignited the cotton bed.

Horizontal Burn Test: The Horizontal Burn Test is conducted in accordance with UL-2556. The test is performed by placing the coated conductor in a horizontal position. Cotton is placed underneath the coated conductor. A burner is set at a 20° angle relative to the horizontal sample (14 AWG copper wire with 30 mil coating wall thickness). A one-time flame is applied to the middle of the sample for 30 seconds. The sample fails when (i) the cotton ignites and/or (ii) the sample chars in excess of 100 mm. Char length is measured in accordance with UL-1581, 1100.4. The test is repeated 3 times.

### Materials

The materials used in the examples are provided below.

Silane functionalized polyolefin 1 is an ethylene/silane copolymer having a density of 0.922 g/cc, a crystallinity at 23° C. of 46.9 wt % and a melt index of 1.5 g/10 min (190° C./2.16 kg) and is commercially available as SI-LINK™ DFDA-5451 NT from The Dow Chemical Company, Midland, Mich. Silane functionalized polyolefin 1 has a Temperature of 5% Mass Loss of 425° C. as measured according to Thermogravimetric Analysis (except for a rate of 10° C./minute, instead of rate of 20° C./minute used with the brominated FR). Silane functionalized ppolyolefin 1 has a Retained Mass at 650° C. of 0 wt % as measured according to Thermogravimetric Analysis (except for a rate of 10° C./minute, instead of rate of 20° C./minute used with the brominated FR).

Silane functionalized polyolefin 2 is an ethylene/silane copolymer having a density of 0.922 g/cc, a crystallinity at 23° C. of 46.2 wt % and a melt index of 1.5 g/10 min (190° C./2.16 kg) and is commercially available as SI-LINK™ AC DFDB-5451 NT from The Dow Chemical Company, Midland, Mich.

ULDPE is a polyethylene resin having a density of 0.904 g/cc, a crystallinity at 23° C. of 37 wt % and a melt index of 4 g/10 min (190° C./2.16 kg) and is commercially available as ATTANE™ 4404 G from The Dow Chemical Company, Midland, Mich.

LLDPE is a linear low-density polyethylene resin having a density of 0.920 g/cc, a crystallinity at 23° C. of 49 wt % and a melt index of 3.5 g/10 min (190° C./2.16 kg) and is commercially available as DOW™ LLDPE 1648 from The Dow Chemical Company, Midland, Mich.

Brominated FR is ethylene bis-tetrabromophthalimide and is commercially available as SAYTEX™ BT-93W from Albemarle, Charlotte N.C. The Brominated FR has a Temperature of 5% Mass Loss of 442° C. as measured according to Thermogravimetric Analysis. The Brominated FR has a Retained Mass at 650° C. of from 10 wt % to 20 wt % as measured according to Thermogravimetric Analysis.

Antimony trioxide 1 is Sb₂O₃ commercially available as BRIGHTSUN™ HB500 from China Antimony Chemicals Co. Ltd, Beijing, China.

Antimony trioxide 2 is Sb₂O₃ commercially available as MICROFINE™ AO9 from Chemtura, West Lafayette, Ind.

AO is a sterically hindered phenolic antioxidant having the chemical name pentaerythritol tetrakis(3-(3,5-di-tert-butyl-4-hydroxyphenyl)propionate), which is commercially available as IRGANOX™ 1010 from BASF, Ludwigshafen, Germany.

HALS is a hindered amine light stabilizer described by the CAS number 106990-43-6 and commercially available as CHIMASSORB™ 119 from BASF, Ludwigshafen, Germany.

Catalyst Masterbatch 1 is a blend of polyolefins, phenolic compounds, and 1.7 wt % of dibutyltin dilaurate as silanol condensation catalyst.

Catalyst Masterbatch 2 is a is a blend of polyolefins, phenolic compounds, and 2.6 wt % of dibutyltin dilaurate as silanol condensation catalyst.

### Sample Preparation

IE1 and IE3: Prepare the samples by melt blending the materials of Table 1, except the catalyst masterbatches, in a BRABENDER™ mixer at 70 revolutions per minute for 3 minutes at a temperature between 140° C. to 195° C. Press the melt blended samples into plaques and cut the plaques into pellets. Dry the pellets in a vacuum oven for 16 hours at 70° C. Solid blend the pellets with pellets of the designated catalyst masterbatch. Melt mix the combined pellets using a ¾ inch BRABENDER™ extruder and a standard polyethylene screw with a temperature profile of 150° C./180° C./180° C./180° C. Extrude the material onto a 14 American wire gauge solid copper wire to form cables having polymeric sheaths of 0.762 mm thickness. Cure the cables in a 90° C. water bath for 16 hours.

IE2 and IE4: Flame-retardant masterbatches were prepared by mixing all ingredients of Table 1, except silane functionalized polyolefin 2 and catalyst masterbatch 2. The ingredients were all pre-weighed and manually fed at phase 1 and mixed by a Farrel BANBURY™ mixer of size D with 150 hp variable speed drive. Individual batch sizes were 40 lbs with batch mixing time of 6-7 minutes and a drop temperature of 145° C.-150° C. After mixing, the material was fed into a Farrel 8″×45″ melt fed single screw extruder with 150 horsepower variable speed drive and 14/1 nominal length/diameter. The extruder output was 252 lbs./hr. at 23 revolutions per minute with indicated melt temperature 146° C.-155.5° C. and extrudates were pelletized by underwater cutter.

After being dried by a Conair dryer 60° C. for more than 24 hours, the pellets of flame-retardant masterbatches were dry blended with pellets of silane functionalized polyolefin 2 and catalyst masterbatch 2. The dry blended compounds were subsequently melt-extruded onto 14 American wire gauge solid copper wire to form cables having polymeric sheaths of 32 mil thickness using a 2.5 inch Davis Standard wire and cable extruder with a polyethylene type Maddock mixing head screw with a 3:1 compression ratio and screen pack of 20/40/60/20 mesh. The discharge from this extruder flowed through a Guill type 9/32×⅝ inch adjustable center crosshead and through the specified tubing tip and coating die. The set temperature profile on the extruder was 130/135/143/149/152/166/166/166° C. with measured melt temperatures ranging from 176 to 183° C. Line speeds were 300 ft/min, Extrusion revolutions per minute were 43-44.5 and pressures were from 12.5-19.3 megaPascals. The cables were subsequently cured in a 90° C. water bath for 16 hours.

Table 1 provides the materials used to form Inventive Examples (IE″) 1-4. The amount of each material used is given in weight percent based on the total weight of the respective Inventive Example.

TABLE 1

| Material | IE1 | IE2 | IE3 | IE4 |
|---|---|---|---|---|
| Silane functionalized | 38.80 | 0 | 38.80 | 0 |
| polyolefin 1 | | | | |
| Silane functionalized | 0 | 70.00 | 0 | 70.00 |
| polyolefin 2 | | | | |
| ULDPE | 14.36 | 0 | 14.36 | 0 |
| LLDPE | 0 | 7.735 | 0 | 9.985 |
| Brominated FR | 34.92 | 13.500 | 32.79 | 11.250 |
| Antimony trioxide 2 | 8.73 | 0 | 10.86 | 0 |
| Antimony trioxide 1 | 0 | 3.750 | 0 | 3.750 |
| AO | 0.19 | 0.013 | 0.19 | 0.013 |
| HALS | 0 | 0.003 | 0 | 0.003 |
| Catalyst Masterbatch 1 | 3.00 | 0 | 3.00 | 0 |
| Catalyst Masterbatch 2 | 0 | 5.000 | 0 | 5.000 |
| Total wt % | 100.00 | 100 | 100.00 | 100 |
| Sb:Br Molar Ratio | 0.204 | 0.227 | 0.270 | 0.272 |

### Results

Table 2 provides results of testing of Inventive Examples 1-4.

TABLE 2

| Test | IE1 | IE2 | IE3 | IE4 |
|---|---|---|---|---|
| VW-1 | 0 | N/A | 39 | N/A |
| Average Time | | | | |
| to Self- | | | | |
| Extinguish | | | | |
| (sec) | | | | |
| VW-1 Cotton | No | N/A | No | N/A |
| Ignited | | | | |
| VW-1 Pass or | Pass (3 of 3 | N/A | Pass (2 of 3 | N/A |
| Fail | specimens) | | specimens) | |
| Horizontal | N/A | 17.3 | N/A | 3.3 |
| Burn Time | | | | |
| to Self- | | | | |
| Extinguish | | | | |
| (sec) | | | | |
| Horizontal | N/A | 45.3 | N/A | 39.3 |
| Burn Total | | | | |
| Char (mm) | | | | |
| Horizontal | N/A | Pass (3 of 3 | N/A | Pass (3 of 3 |
| Burn Pass | | specimens) | | specimens) |
| or Fail | | | | |

As can be seen from Table 2, all IE1-IE4 were able to pass either the VW-1 or the horizontal burn test. Such a result is surprising in that the understanding in the prior art, as highlighted in the background section of the present application, explicitly set a lower limit on the Sb:Br molar ratio of 0.37 for passing the VW-1 burn Test or the Horizontal Burn Test. IE1-IE4 each had a Sb:Br molar ratio of greater than 0 and less than 0.37 and still succeeded in passing the VW-1 burn Test or the Horizontal Burn Test.

1. A polymeric composition comprising:
a silane functionalized polyolefin;
a brominated flame retardant having a Temperature of 5% Mass Loss from 350° C. to 500° C. and from 2 wt % to 50 wt % Retained Mass at 650° C., wherein the 5% Mass Loss and Retained Mass at 650° C. are measured according to Thermogravimetric Analysis; and
antimony trioxide,
wherein the polymeric composition has an antimony (Sb) to bromine (Br) molar ratio (Sb:Br molar ratio) of greater than 0.0 to 0.35.

2. The polymeric composition of claim 1, further comprising:
0.001 wt % to 5.0 wt % of a silanol condensation catalyst based on a total weight of the polymer composition.

3. The polymeric composition of claim 1, further comprising:
5 wt % to 30 wt % of a second polyolefin based on a total weight of the polymeric composition, wherein the second polyolefin has a crystallinity at 23° C. of from 0 wt % to 80 wt % as measured according to Crystallinity Testing.

4. The polymeric composition of claim 3, wherein the brominated flame retardant comprises ethylene bis-tetrabromophthalimide

5. The polymeric composition of claim 4, wherein the polymeric composition comprises from 5 wt % to 45 wt % of ethylene bis-tetrabromophthalimide based on a total weight of the polymeric composition.

6. The polymeric composition of claim 4, wherein the polymeric composition comprises from 1 wt % to 15 wt % of antimony trioxide based on a total weight of the polymeric composition.

7. The polymeric composition of claim 1, wherein the Sb:Br molar ratio is from 0.20 to 0.30.

8. A coated conductor comprising:
a conductor; and
the polymeric composition of claim 1 disposed at least partially around the conductor.

9. The coated conductor of claim 8, wherein the coated conductor passes a Horizontal Burn Test.

10. The coated conductor of claim 9, wherein the coated conductor passes a VW-1 Bum Test.
